(19) United States
(12) Patent Application Publication
(10) Pub. No.: US 2016/0298459 A1
(43) Pub. Date: Oct. 13, 2016

(54) ROTOR DAMPER

(71) Applicant: ROLLS-ROYCE plc, London (GB)

(72) Inventors: Michael F. BRYANT, Bristol (GB); Garry M. EDWARDS, Clevedon (GB)

(73) Assignee: ROLLS-ROYCE plc, London (GB)

(21) Appl. No.: 15/094,393

(22) Filed: Apr. 8, 2016

(30) Foreign Application Priority Data
Apr. 13, 2015 (GB) 1506197.1

(51) Int. Cl. F01D 5/10; F01D 5/34

(52) U.S. Cl. CPC F01D 5/10; F01D 5/34; F05D 2220/32; F05D 2240/20; F05D 2240/80; F05D 2260/96

(57) ABSTRACT

A rotor stage of a gas turbine engine includes a platform from which rotor blades extend. The platform is provided with a circumferentially extending damper ring, the damper ring having an engagement surface that engages with a platform engagement surface of the platform. The platform engagement surface and the damper engagement surface can move relative to each other in the radial direction. In use, the damper engagement surface moves less in the radial direction than the platform engagement surface in response to diametral mode excitation. This causes friction between the two surfaces, thereby dissipating energy and damping the excitation. The platform engagement surface and the damper engagement surface engage over at least two separate engagement portions separated by a gap.

### CROSS-REFERENCE TO RELATED APPLICATIONS

This application is based upon and claims the benefit of priority from British Patent Application Number 1506197.1 filed 13 Apr. 2015, the entire contents of which are incorporated by reference.

### BACKGROUND

1. Field of the Disclosure

The present disclosure concerns a damper for a rotating part of a gas turbine engine.

2. Description of the Related Art

A gas turbine engine comprises various stages of rotor blades which rotate in use. Typically, a gas turbine engine would have at least one compressor rotor stage, and at least one turbine rotor stage.

There are a number of ways in which the blades of a rotor stage may be attached to the engine. Generally, the blades attach to a rotating component, such as a disc, that is linked to a rotating shaft. Conventionally, blades have been inserted and locked into slots formed in such discs.

Integral bladed disc rotors, also referred to as blisks (or bliscs), have also been proposed. Such blisks may be, for example, machined from a solid component, or may be manufactured by friction welding (for example linear friction welding) of the blades to the rim of the disc rotor.

Blisks have a number of advantages when compared with more traditional bladed disc rotor assemblies. For example, blisks are generally lighter than equivalent bladed disc assemblies in which the blades are inserted and locked into slots in the disc because traditional blade to disc mounting features, such as dovetail rim slots, blade roots, and locking features are no longer required. Blisks are therefore increasingly used in modern gas turbine engines, for example as part of the compressor section (including the fan of a turbofan engine).

Typically blisks are designed where possible to avoid vibration responses from, for example, resonance and flutter, which may be distortion driven. However, blisks lack inherent damping when compared to conventional bladed disc assemblies and resonances and flutter cannot always be avoided.

Additionally, the outer surface or rim of the blisk disc portion typically forms the inner annulus for working fluid in the gas turbine engine, such as at the compressor inlet. Thus the requirement for the inner annulus position fixes the blisk outer rim radius from the engine centre line thereby determining the basic size/shape of the disc portion. Accordingly, it may not be possible to design a blisk that avoids all forced vibration responses within such constraints.

### OBJECTS AND SUMMARY

Accordingly, it is desirable to be able to provide efficient and/or effective damping to a rotor stage, for example to a bladed disc, or blisk. It is desirable to provide such efficient and/or effective damping in a manner that is consistent over time and/or does not cause damage and/or unacceptable wear to any of the components.

According to an aspect, there is provided a rotor stage for a gas turbine engine comprising: a plurality of blades extending from a platform, the platform extending circumferentially about an axial direction; and a circumferentially extending damper element. The platform comprises a platform engagement surface. The damper element comprises a damper engagement surface. The platform engagement surface engages the damper engagement surface over at least two separate engagement portions, the engagement portions being separated by a gap over which the platform engagement surface does not engage the damper engagement surface.

The at least two engagement portions may together be said to form an engagement surface. Such an engagement surface may be said to be a discontinuous engagement surface, in that it is formed by at least two engagement portions separated by at least one gap.

The platform engagement surface may be formed on any suitable part of the platform, or rim. The platform may in some arrangements be a rim of a rotor disc or blisk.

As used herein, the terms “axial” and/or “axis” may refer to the axial (or rotational) axis of a gas turbine engine and/or the rotor stage. Similarly, the terms “radial” and “circumferential” may refer to the radial and circumferential directions of a gas turbine engine and/or the rotor stage.

Excitation of the rotor stage may cause relative movement (which may be referred to as relative radial movement) between the damper engagement surface and the platform engagement surface. Thus, the damper engagement surface and the platform engagement surface may be moveable relative to each other in the radial direction. This relative movement may be caused by radial movement (which may be and/or include radial oscillation (including, for example, elliptical oscillation) at a given circumferential position) of the platform engagement surface due to the diametral mode vibration/excitation. The damper engagement surface may be substantially stationary, at least in the radial direction and/or at least in comparison to the movement (for example radial movement) of the platform engagement surface (thus resulting in relative radial movement between the damper engagement surface and the platform engagement surface). The damper element (and/or the damper engagement surface) may be said to be more radially fixed and/or less radially mobile and/or more dimensionally stable in the radial direction and/or more radially rigid (or less radially flexible) than the platform (and/or the platform engagement surface), for example in response to diametral mode excitation.

The damper engagement surface and the platform engagement surface may be moveable relative to each other (and, for example, may actually move relative to each other in use) in the circumferential direction. Thus, for example, the damper engagement surface and the platform engagement surface may be moveable relative to each other in both the circumferential direction and the radial direction. Purely by way of example, in use, the movement of two initially coincident points—one on the damper engagement surface and the platform engagement surface—may take an elliptical shape. Also by way of example, the major axis of such an ellipse may be in the radial direction. The slip may be described as being predominantly in the radial direction.

Relative movement between the platform engagement surface and the damper engagement surface may result in frictional damping. Such frictional damping may be provided due to frictional losses being generated at the interface between the two surfaces as they move, and thus rub against, each other. Such frictional damping may be effective in damping vibration (for example diametral mode vibration) in the rotor stage during use, for example during use in a gas turbine engine. Accordingly, the arrangements and/or methods described and/or claimed herein may provide improved damping.

The gaps in the engagement surface may reduce the effects on damage and/or wear (for example fretting) during use. For example, the gaps mean that stress loads (for example hoop stress loads) in the component(s) are not intended (for example designed) to be carried at or in the region of the engagement surface(s). Instead, such stress loads are carried in a portion of the component away from the engagement surface(s). Accordingly, an effect of the gaps between the engagement portions is to reduce (for example substantially eliminate) the impact of any damage and/or wear that occurs at the engagement surface(s) over time on the load carrying capacity (for example the hoop stress capacity) of the components.

The engagement portions may be circumferentially extending segments. For example, the engagement portions may be segments that extend in a circumferential-radial plane, which may be a plane that is perpendicular to the axial direction. The engagement portions may be annular segments, for example annular segments that are perpendicular to the axial direction. The engagement portions may take any other suitable shape, for example segments of a frusto-cone.

The platform may be ridged (and/or may comprise ridges), thereby forming the at least two engagement portions separated by a gap. The ridges may form the platform engagement surface. The ridges may form the engagement portions, for example by engaging with the damper engagement surface. Such ridges may be circumferentially extending and/or may be described as segments of a disc or hoop.

Such a platform (or rim) comprising ridges may alternatively be referred to as a scalloped platform, a platform having at least one scalloped edge and/or a platform having cut-outs on at least on edge.

In arrangements in which the platform is ridged, the ridges may protrude in a substantially axial direction. Such ridges may be said to extend from a base surface of the platform (which may be perpendicular to an axial direction) in an axial direction. The tips of such ridges may form the platform engagement surface. The tips of such ridges may be segments of an axisymmetric surface. The tips of such ridges may be segments of an annulus that is perpendicular to the axial direction. Where the ridged platform is said to be scalloped, the scallops may be formed as axially extending cut-outs from a surface substantially perpendicular to axial direction.

By way of further example, alternatively, the ridges may protrude in a substantially radial direction. Such ridges may be said to extend from a base surface of the platform (which may extend in a circumferential-axial direction, i.e. perpendicular to the local radial direction) in a radial direction. Side surfaces of such ridges may form the platform engagement surface. Such side surfaces may be segments of an axisymmetric surface. The tips of such ridges may be segments of an annulus that is perpendicular to the local radial direction, i.e. an annulus that extends in the circumferential-axial direction. Where the ridged platform is said to be scalloped, the scallops may be formed as radially extending cut-outs from a surface substantially perpendicular to the local radial direction.

Regardless of the form that the ridges take, the engagement surfaces may be substantially the same, for example any arrangement of ridges may form any of the arrangements of engagement surfaces described and/or claimed herein.

The damper engagement surface may be axisymmetric. The platform engagement surface be non-axisymmetric, for example. However, the damper engagement surface may be non-axisymmetric, for example comprising annular segments.

The damper engagement surface may take any suitable form, for example it may be an annular surface. Such an annular surface may be formed around the axial direction and/or may be perpendicular to the axial direction.

The platform engagement surface may take any suitable form, for example it may be annular and/or formed by annular segments (which may, for example, be formed by ridges and/or scallops). Such an annular surface (or segments thereof) may be formed around the axial direction and/or may be perpendicular to the axial direction.

The damper element may be an annular disc, for example a thin-walled annular disc. The thin wall (which may be referred to as the thickness) may be said to be in the axial direction. The axial thickness of such a thin-walled annular disc may be, for example, less than (for example less than 25%, 20%, 15%, 10%, 5% or 2% of) the distance between the inner and outer radii of the annulus. Such an annular disc may be formed around the axial direction and/or may have one or more annular surfaces that are perpendicular to the axial direction. The damper element may be referred to as a damper ring.

As mentioned elsewhere herein, the damper engagement surface and the platform engagement surface may be substantially perpendicular to the axial direction. This may mean that the damper engagement surface and the platform engagement surface are perpendicular to the axial direction and/or have a major component perpendicular to the axial direction. The surface normal to the damper engagement surface and the platform engagement surface may be slightly inclined to the axial direction (for example by less than 20 degrees, for example less than 10 degrees, for example less than 5 degrees, for example less than 2 degrees), so as to, for example, have a radial component. Such slightly inclined engagement surfaces may be described as being conical, as well as being substantially perpendicular to the axial direction. In other arrangements, the damper engagement surface and the platform engagement surface may be, for example, perpendicular to the radial direction.

In some arrangements, the damper element may contact the platform only where the damper engagement surface and the platform engagement surface engage.

The damper engagement surface and the platform engagement surface may be moveable relative to each other in a radial direction at least. In such an arrangement, the platform may be more radially deformable than the damper element. This may mean, for example, that the platform (and thus the platform engagement surface) moves more under diametral mode excitation (which may be caused, for example, during normal use of the rotor stage) than the damper element (and thus the damper engagement surface).

As mentioned elsewhere herein, the platform engagement surface engages the damper engagement surface over at least two separate engagement portions. Purely by way of example, there may be two, more than two, more than 3, more than four, more than five, for example more than ten, more than twenty, or more than fifty engagement portions. In general, the rotor stage may comprise as many engagement portions as desired.

The rotor stage may comprise a contact layer on one or both of the platform engagement surface and the damper engagement surface. The contact layer may comprise, for example, a low-friction layer, which may be defined as a layer that has lower friction than the underlying surface to which it is applied. The contact layer may comprise, for example a hard layer, which may be defined as a layer that has increased hardness compared with the underlying surface to which it is applied.

Purely by way of example, Molybdenum Disulphide (MoS₂) may be used as a lubricant coating, and Tungsten Carbide may be used as a hard coating.

Such a contact layer, where present, may be formed in any suitable manner. For example, a contact layer may be formed by performing a process on the surface of the existing material. By way of further example, a contact layer may be formed by applying a coating having the desired properties to the underlying surface.

The damper element may have a body portion and an engagement portion. The engagement portion may comprise the damper engagement surface that is in contact with the platform. Regardless of the material of the damper element (for example whether it is manufactured using one, two, or more than two materials), the engagement surface may be the surface that slips relative to the platform during excitation (or vibration) of the platform. In arrangements in which the damper element comprises a body portion and an engagement portion, the engagement portion may be manufactured using a first material, and the body portion may be manufactured using a second material. In such an arrangement, and purely by way of example only, the first material may be metal and/or the second material may be a composite, such as a fibre reinforced and/or polymer matrix composite, such as carbon fibre. In such an arrangement, the body portion and the engagement portion may, for example, be bonded together.

The damper element and the platform may be axially biased together. This may provide an engagement load between the damper engagement surface and the platform engagement surface. The engagement load may be referred to as a pre-load. The engagement load may be pre-determined (for example selected through testing and/or modelling) to provide the optimum damping.

Any suitable engagement load may be used. The value of engagement load may depend on, for example, the geometry and/or material and/or mechanical properties (for example stiffness and/or coefficient of friction) of the rotor stage and/or the gas turbine engine in which the rotor stage is provided. The value of the engagement preload may depend on, for example, the relative movement between the damper engagement surface and the platform engagement surface which may itself depend on the flexibility of the platform and/or stiffness of the damper element.

Purely by way of example, the engagement load may be (or result in an engagement pressure that is) in the range of from 1 MPa to 100 MPa, for example 2 MPa to 50 MPa, for example 5 MPa to 40 MPa, for example 10 MPa to 30 MPa, for example on the order of 20 MPa. However, of course, engagement loads below 1 MPa and above 100 MPa are also possible, depending on the application.

The rotor stage may comprise a biasing element. Such a biasing element may urge the platform engagement surface and damper engagement surface together, for example to provide an engagement load such as that described above and elsewhere herein. For example, the biasing element may provide a force in the axial direction to the damper element to push the damper engagement surface onto the platform engagement surface. Such a biasing element may take any suitable form, such as a clip and/or a spring. A biasing element may be useful, for example, in providing a particularly consistent engagement load over time, for example regardless of any wear (and thus dimensional and/or tolerance change) that may have taken place over time, for example at the interface of the platform engagement surface and damper engagement surface.

The rotor stage may take any suitable form. For example, the plurality of blades may be formed integrally with the platform (for example as a unitary part), as a blisk. In such an arrangement, the platform may be the rim of the blisk. The rotor stage may comprise a disc on which the platform is provided.

Arrangements having integrated disc, platform and blades may be referred to as a blisk. Arrangements having an integrated disc and platform but no disc may be referred to as a bling (bladed ring), although the term blisk as used herein may be used to refer to any arrangement (blisk or bling) having an integrated platform and blades, regardless of whether a disc is also provided.

According to an aspect, there is provided a method of damping vibrations in a rotor stage of a gas turbine engine, wherein the rotor stage is a rotor stage as described and/or claimed herein. According to such a method, the vibration may comprise a travelling wave passing circumferentially around the circumferentially extending platform. Such wave may be an example of and/or may result from diametral mode excitation/vibration. According to such a method, the damping is provided by frictional damping generated through slip between the platform engagement surface and the damper engagement surface. The slip may comprise radial slip. The slip may comprise circumferential slip, for example in addition to radial slip.

The magnitude of the frictional damping may depend upon, for example, the load with which the surfaces are pushed together and/or the amount of relative movement between the surfaces.

The damper element may comprise openings or holes. For example, the damper element may comprise substantially axially aligned holes (that is, holes with an axis extending in the direction of the rotational axis of the rotor stage, for example perpendicular to the major surfaces of the damper element) that extend through the rest of the damper element. For example, the damper element may be a substantially annular (or disc-shaped) body with holes extending therethrough. Such holes may provide access to regions that would otherwise be sealed and/or difficult to access due to the presence of the damper element, for example to access fixings such as bolts. Additionally or alternatively, such holes may provide ventilation and/or cooling to regions that would otherwise be substantially sealed by the damper element, for example a region between the damper element and a drive/root portion of the rotor stage, as shown by way of example in the Figures.

A rotor stage as described and/or claimed herein may be provided with one or more than one damper element. Where more than one damper element is provided, two damper elements may be axially offset from each other.

The platform may have a radially inner surface. Purely by way of example, the platform engagement surface may be formed in the radially inner surface. The damper element may be provided to the radially inner surface. The damper element and/or platform engagement surface may be on the opposite side of the platform to that from which the blades extend.

The platform engagement surface and the damper engagement surface may have the same shape and/or may have overlapping shapes.

The damper element may be (for example have a shape that is) particularly resistant to deformation or deflection (for example particularly stiff or rigid) in the radial direction. The damper element may be (for example have a shape that is) particularly resistant to deformation (for example particularly stiff or rigid) perpendicular to the axial direction. Particularly resistant to deformation may mean that it is more resistant to deformation in that direction that to deformation in other directions.

The damper element may have any suitable cross-sectional shape. For example, the damper element may have a cross-sectional shape in a plane perpendicular to the circumferential direction of the rotor stage that is stiffer (for example has a higher second moment of area) about an axially extending bending axis than about a radially extending bending axis. The damper element may, for example, have a rectangular shaped, T-shaped or I-shaped cross section, although a great many other cross-sections are possible, of course.

The dimension (or extent) of the cross-section in the radial direction of such a cross-section may be greater than the dimension (or extent) of the cross-section in the axial direction.

The damper element may comprise at least one stiffening rib. For example, such a stiffening rib may extend axially. Such a stiffening rib may extend around all or a part of the circumference.

The damper element may be manufactured using any suitable material. For example, the damper element may be manufactured using a single material and/or may be said to be homogeneous. The damper element may comprise two (or more than two) different materials.

The damper element may be radially fixed to a dimensionally stable part of the gas turbine engine, for example to a part of the gas turbine engine that is not susceptible to diametral mode vibration during operation. Such a dimensionally stable part may be, for example, a drive assembly. Such a drive assembly may be arranged to transfer rotational drive, for example to (or from) the platform and/or the blades mounted thereto. Such a drive assembly may be considered to be a part of the rotor stage, for example where at least a part of it is used to drive the rotor stage. The rotational drive may, for example, be transferred from a shaft (which may be referred to as a rotating shaft) of the gas turbine engine, which may be connected between the turbine and the compressor of a gas turbine engine so as to transfer power therebetween. In operation, the drive assembly typically rotates at the same rotational speed as the rotor stage that it is driving. The damper element may be radially fixed (for example connected or attached) to such a drive assembly.

The drive assembly may be very dimensionally stable, for example experiencing substantially no radial movement during operation, even if, for example, other parts of the gas turbine engine and/or rotor stage are experiencing diametral mode vibration. The drive assembly may be considered to be rigid, at least in a radial sense, for example substantially more rigid than other parts of the rotor stage, including the platform. Accordingly, radially fixing the damper element to the drive assembly may assist in limiting (or substantially eliminating) the radial movement of the damper element during operation, although it will be appreciated that radial fixing of the damper element to the drive assembly is not essential for the operation.

In any arrangement described and/or claimed herein, the damper element may extend from a radially inner end (which may be a circle/cylindrical surface/frusto cone or a segment of a circle/cylindrical surface/frusto cone) to a radially outer end which may be a circle/cylindrical surface/frusto cone or a segment of a circle/cylindrical surface/frusto cone). In arrangements in which the damper element is radially fixed to the drive assembly, it may be a radially inner end region of the damper element that is radially fixed to the drive assembly. The damper element may thus be (and/or be manufactured as) a separate component to the rest of the rotor stage, and subsequently attached to the rotor stage by any suitable method.

A drive assembly may comprise a fixing hook. The damper element may comprise a fixing hook that corresponds to the drive assembly fixing hook. The drive assembly fixing hook and the corresponding damper fixing hook may be engaged so as to radially fix the damper element to the drive assembly. The fixing hooks may take any suitable form, for example they may be axially extending and/or may engage at surfaces that form cones, frusto cones or segments thereof.

As noted above, the damper element may be fixed, for example in all degrees of freedom, to a dimensionally stable component, such as to a drive assembly. For example the damper element may be fixed to a drive assembly using a fixing element. Such a fixing element may take any suitable form, such as a threaded fixing element (such as a bolt) or a rivet. Where a fixing element is used, the engagement load may be adjusted by adjusting the fixing element, for example tightening and/or loosening the fixing element.

The damper element may be (at least) radially fixed to any part of a drive assembly. For example, the drive assembly may comprise a drive arm to which the damper element may be (at least) radially fixed, for example at an inner radial extent of the damper element. A drive arm may be considered to be any component that is arranged to transfer torque during operation, for example between a rotating shaft and the blades of the stage. Such a drive arm may, for example, extend between a shaft and a disc or ring on which the platform may be provided. By way of further example, the drive arm may transfer torque across the axial space between neighbouring rotor stages and may be referred to as a spacer. The drive assembly may also be considered to include a disc or ring on which the platform may be provided.

In any arrangement, the damper engagement surface may be at a radially outer end region of the damper element.

The platform may have a groove (or slot) formed therein. Such a groove may be formed in a radially inner surface of the platform, which may be on the side of the platform that is opposite to the side from which the blades extend. The damper element may be retained in and/or by such a groove. The damper element may be said to sit in and/or be located by and/or at least partly located in such a groove.

The groove may have a generally U-shaped cross-section and/or may be formed by two surfaces extending in a radial-circumferential plane separated and joined by a surface extending in the axial-circumferential direction. The platform engagement surface may be a part of such a groove. For example, one or two surfaces of the grove extending in a substantially radial-circumferential plane may be platform engagement surface(s).

In general, regardless of whether a groove is provided, one or more than one platform engagement surface may be provided, each platform engagement surface engaging with a corresponding damper engagement surface. Where two or more platform engagement surfaces are provided, they may be axially offset from each other.

In any arrangement, a lubricant, such as a dry film lubricant, may be provided between the platform engagement surface and the damper engagement surface. Such a lubricant may assist in providing a particularly consistent coefficient of friction at the engagement surface, for example during use and/or over time.

It will be appreciated that the damper element could be provided on any suitable surface of the platform, for example on a radially inner or radially outer side of the platform. The damper engagement surface may, for example, engage a platform engagement surface that is at (or that forms) and axially forward or axially reward surface of the platform, for example.

According to an aspect, there is provided a gas turbine engine comprising at least one rotor stage as described and/or claimed herein.

Any feature described and/or claimed herein, for example in relation to any one of the above features, may be applied/used singly or in combination with any other feature described and/or claimed herein, except where mutually exclusive.

### BRIEF DESCRIPTION OF THE DRAWINGS

Non-limitative examples will now be described with reference to the Figures, in which:

FIG. 1 is a sectional side view of a gas turbine engine in accordance with an example of the present disclosure;

FIG. 2 is a schematic view of a part of a rotor stage of a gas turbine engine, including a damper element, in accordance with an example of the present disclosure;

FIG. 3 is a different schematic view of a part of the rotor stage of a gas turbine engine shown in FIG. 2, thus including a damper element in accordance with an example of the present disclosure;

FIG. 4 is a schematic view of a part of a rotor stage of a gas turbine engine, including a damper element, in accordance with an example of the present disclosure;

FIG. 5 is a different schematic view of a part of the rotor stage of a gas turbine engine shown in FIG. 4, thus including a damper element in accordance with an example of the present disclosure;

FIG. 6 is a schematic view of a part of a rotor stage of a gas turbine engine, including a damper element, in accordance with an example of the present disclosure;

FIG. 7 is a schematic view of a part of a rotor stage of a gas turbine engine, including a damper element, in accordance with an example of the present disclosure;

FIG. 8 is a schematic view of a part of a rotor stage of a gas turbine engine, including a damper element, in accordance with an example of the present disclosure;

FIG. 9 is a schematic view of a part of a rotor stage of a gas turbine engine, including a damper element, in accordance with an example of the present disclosure;

FIG. 10 is a schematic view of a part of a rotor stage of a gas turbine engine, including a damper element, in accordance with an example of the present disclosure; and

FIG. 11 is a schematic view of a part of a rotor stage of a gas turbine engine, including a damper element, in accordance with an example of the present disclosure.

### DETAILED DESCRIPTION OF EMBODIMENTS

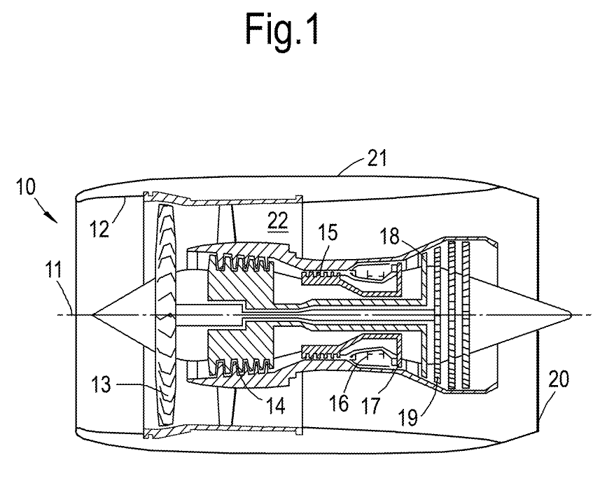

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, and intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Each of the high 17, intermediate 18 and low 19 pressure turbines and each of the fan 13, intermediate pressure compressor 14 and high pressure compressor 15 comprises at least one rotor stage having multiple blades (or aerofoils) that rotate in use. One or more rotor stage may be, for example, a disc with slots (which may be referred to as dovetail slots or fir-tree slots) for receiving the blade roots. One or more rotor stages may have the blades formed integrally with the supporting disc or ring structure, and may be referred to as blisks or blings. In such arrangements, the blades may be permanently attached to the supporting disc/ring, for example using friction welding, such as linear friction welding.

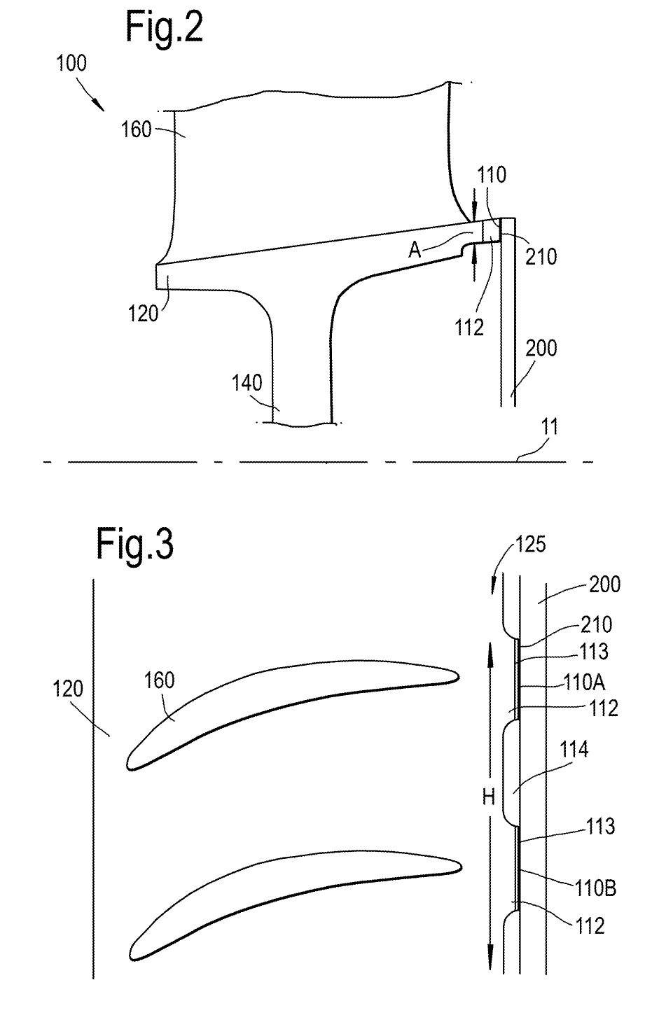

FIG. 2 shows a schematic side view of a part of a rotor stage 100, including a platform 120, a disc 140, a blade 160, and a damper element 200 (which may be a damper ring 200). The platform 120, disc 140 and blade 160 may all be integral, and may be referred to collectively as a blisk. The rotor stage 100 may be any one of the rotor stages of the gas turbine engine 10 shown in FIG. 1, such as (by way of non-limitative example) the fan 13 and/or any one or more stages of one or more of the high 17, intermediate 18 and low 19 pressure turbines and/or the high pressure compressor 15 or intermediate pressure compressor 14.

The damper element 200 has a damper engagement surface 210. The damper engagement surface 210 extends in the radial-circumferential direction in the FIG. 2 arrangement. The damper engagement surface 210 in the example shown in FIGS. 2 and 3 is at a radially outer portion or region of the damper element 200. In this regard, the downstream axial direction 11 is towards the right of the page in FIG. 2, the radially outward direction is towards the top of the page, and the circumferential direction is perpendicular to the page. Accordingly, the rotor stage 100 is shown in cross-section normal to the circumferential direction in FIG. 2.

FIG. 3 is a view of the rotor stage 100 shown in FIG. 2 looking along a radial direction (relative to the rotation of the rotor stage 100 during use).

The damper engagement surface 210 engages a corresponding platform engagement surface 110. The platform engagement surface 110 comprises at least two portions (or segments) separated by a gap 114. The segments of the engagement surface 110 may be formed on a surface of ridges 112 of the platform 120, as in the example shown in FIGS. 2 and 3. In the example shown in FIGS. 2 and 3, the ridges 112 protrude (for example from a base to a tip) in an axial direction 11, with the engagement surface portions 110 being formed on an axially downstream surface of the ridges 112 (which may be referred to as protrusions). The ridges 112 and the gaps 114 may together be said to form a scalloped edge on the platform 120.

The portions at which the platform engagement surface 110 engages the damper engagement surface 210 may be referred to as engagement portions 110A, 110B, as shown most clearly by way of example in FIG. 3. These engagement portions 110A, 110B are separated by the gap 114, over which the damper engagement surface 210 and the platform engagement surface 110 are not engaged. The engagement portions 110A, 110B may be annular segments, as in the example of FIGS. 2 and 3, in which the annular segments are segments of an annulus that extends around the axial direction 11.

The example of FIGS. 2 and 3 comprises a contact layer 113 that forms the platform engagement surface 110. Such a contact layer 113 may be, for example, a low-friction layer that has lower friction than the underlying surface to which it is applied; and/or a hard layer that has increased hardness compared with the underlying surface to which it is applied. The contact layer 113 is optional, and any arrangement in accordance with the present disclosure may not include such a contact layer 113. Some arrangement, however, may have a contact layer 113 forming the damper engagement surface 210, in addition to or instead of the contact layer 113 forming the platform engagement surface 110.

In use, excitation or vibration may cause a circumferential travelling wave to pass around the platform 120. This may be referred to as diametral mode excitation. At a given circumferential position around the circumference, such as at the cross section shown in FIG. 2, this may cause the platform to oscillate in the radial direction. As such, a given circumferential position on the platform 120 may move radially inwardly and outwardly, as illustrated by the arrow A in FIG. 2. This vibration/oscillation around the platform may, of course, occur during use of any arrangement described and/or claimed herein.

The platform engagement surface 110 therefore may also experience this radial oscillation during use. However, the damper engagement surface 210 does not oscillate, or at least any oscillation is of a significantly lower magnitude than that of the corresponding platform engagement surface(s). This may be because the damper element 200 is not directly fixed to the platform 120. Accordingly, the vibration/excitation of the platform results in relative movement between the platform engagement surface 110 and the damper engagement surface 210. Accordingly, the arrow A in FIG. 2 may be taken to represent the relative movement between the platform engagement surface 110 and the damper engagement surface 210. This relative radial movement results in friction at the interface of the engagement surfaces 110, 210. This friction may result in energy dissipation at the interface, and may provide damping of the oscillation/vibration.

The magnitude of the damping may depend upon, amongst other factors, the engagement load between the platform engagement surface 110 and the damper engagement surface 210. The engagement mode may be the normal load pushing the two engagement surfaces 110, 210 together, for example in the axial direction in the example of FIGS. 2 and 3. Any suitable arrangement may be used for providing an engagement load, examples of which are discussed elsewhere herein.

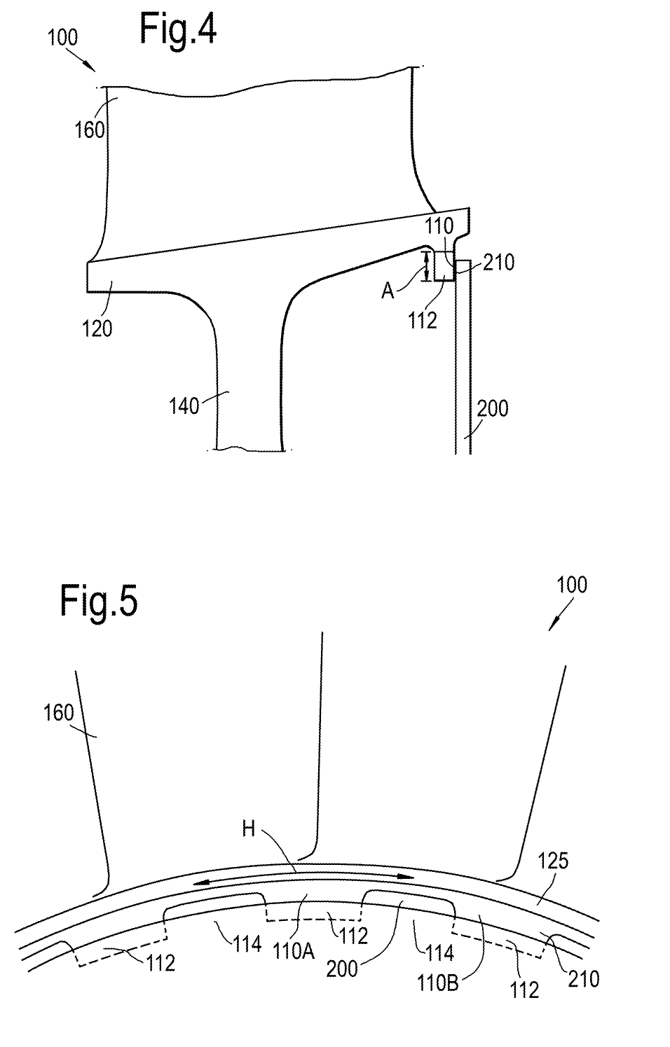

In use, the rotor stage 100 is designed to operate under various loads. One such load is the so-called “hoop-stress” that acts in the circumferential direction of the rotor stage 100, as indicated by the arrow H in FIG. 3. Typically, this hoop-stress H is carried by the platform 120. Providing the platform engagement surface 110 on at least two portions separated by a gap 114 means that very little, or substantially no, hoop-stress is carried in the portion of the platform 120 in which the gaps are formed. This may be because there is no continuous circumferentially extending path in the region, due to the gaps 114. Accordingly, the hoop stress H in the platform 120 is designed to be carried in a portion 125 of the platform 120 that has a continuous circumferential load path, i.e. a portion 125 that is removed from the region with gaps 114 (which may be referred to as the scalloped region). Such a hoop-stress carrying portion 125 may be, for example, axially offset from the region with gaps 114 (as in the example of FIGS. 2 and 3), and/or radially offset from the region with gaps 114 (as in the example of FIGS. 4 and 35, discussed in greater detail below).

Accordingly, the hoop-stress carrying portion 125 of the platform 120 is removed from the engagement portions 110A, 110B. As such, any wear and/or fretting that may occur at the engagement portions 110A, 110B over time as the platform engagement surface 110 and the damper engagement surface 210 move relative to each other has little, for example substantially no, impact on the overall hoop-stress carrying ability of the platform 120 (and/or rotor stage 100). This means that the performance, for example the hoop-stress carrying ability, of the rotor stage 100 can be more consistent over time.

FIGS. 4 and 5 show a further example of a rotor stage 100 in accordance with the present disclosure. The operation of the damper element 200 in the FIGS. 4 and 5 example is similar to that of the example shown and described in relation to FIGS. 2 and 3. However, the example shown in FIGS. 4 and 5 is comprises ridges 112 that point (for example form a base to a tip) in the radial direction. The tip of such ridges 112 may be at a radially inner end of the ridge 112, as in the example shown in FIGS. 4 and 5. The platform engagement surface 110 is provided on a side surface of the ridge 112, the side surface being a surface that extends in a substantially circumferential-radial plane (i.e. a plane that is perpendicular to a substantially axial direction 11). As shown most clearly in FIG. 5, the hoop-stress carrying portion 125 of the platform 120 is removed from the engagement portions 110A, 110B in the radial direction in the example shown in FIGS. 4 and 5.

In other aspects, the rotor stage 100 of the FIGS. 4 and 5 example may be substantially the same as the rotor stage 100 of the FIGS. 2 and 3 example, for example in relation to the shape and/or configuration of the platform engagement surface 110 and the damper engagement surface 210, and the engagement portions 110A, 110B. Accordingly, description provided herein in relation to the FIGS. 2 and 3 example is also relevant to the FIGS. 4 and 5 example, and indeed to the other examples described and/or claimed herein.

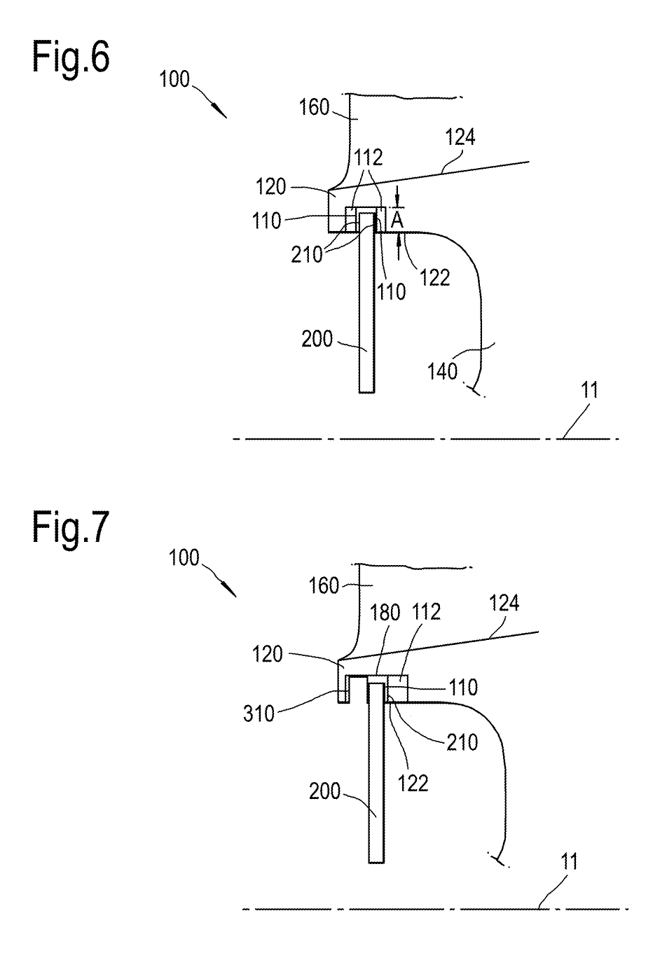

Further examples are described below in relation to FIGS. 6 to 11. In each of the examples, the platform engagement surface 110 engages the damper engagement surface 210 over at least two separate engagement portions. This is shown schematically in the figures by the ridges 112, on which the platform engagement surface(s) 110 are formed, as described above by way of example in relation to FIGS. 2 to 5.

The rotor stage 100 may have two damper engagement surfaces 210, as in the FIG. 6 example, in which the two damper engagement surfaces 210 are offset in the axial direction and parallel to each other. Each engagement surface 210 in the FIG. 2 example is at a radially outer portion or region of the damper element 200.

In the FIG. 6 example, the normal load (or engagement load) is provided by an interference fit of the damper element 200 in a groove. The groove is formed in the inner surface 122 of the platform 120. The groove comprises the first and second engagement surfaces 110 formed by ridges 112, joined by an axially extending surface, which may be a cylindrical surface, as in the FIG. 6 example. The groove may be referred to as a castellated, or scalloped, groove, by virtue of being defined by the ridges 112.

The (or, in arrangements such as that of FIG. 6, each) damper engagement surface 210 engages a corresponding platform engagement surface 110 over at least two engagement portions, such as described above in relation to FIGS. 2 and 3.

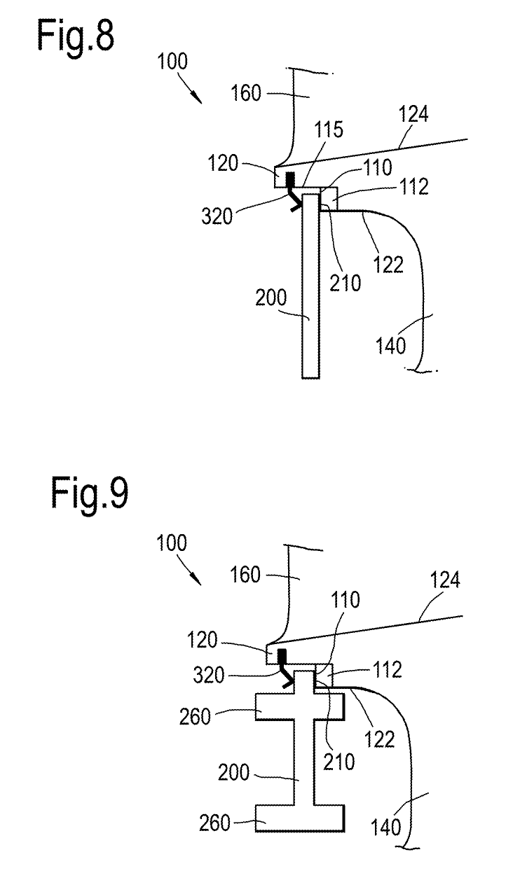

Alternatives to the interference fit of the FIG. 6 example are shown in FIGS. 7 and 8, which may otherwise be constructed and operate as described in relation to FIG. 6, with like features being represented by like reference numerals.

The FIG. 7 arrangement also has a groove 180 formed in the platform 120. However, unlike the FIG. 6 arrangement, in the groove 180 of the FIG. 7 arrangement is wider (for example extends over a greater axial distance) than the damper element 200. The FIG. 7 arrangement has just one damper engagement surface 210 that engages with just one platform engagement surface 110. Once again, the platform engagement surface 110 is formed in at least two portions by ridges 112, thereby forming at least two engagement portions over which the platform engagement surface 110 and the damper engagement surface 210 engage. The platform engagement surface 110 and the damper engagement surface 210 are pushed together by a biasing element 310 in the FIG. 7 arrangement. Accordingly, the biasing element 310 provides the engagement load to press the engagement surfaces 110, 210 together. The biasing element 310 may be provided in the groove 180, for example axially offset from and/or adjacent the damper element 200, as in the FIG. 7 example. The biasing element 310 may take any suitable form, such as a spring and/or a clip. In the FIG. 7 example, the biasing element 310 may be referred to as a clip 310, and may further be described as a u-shaped clip.

The FIG. 8 arrangement is similar to that of FIG. 7, other than in that it does not have a groove 180 and the biasing element 320 has a different form. Instead of being located in a groove, the damper element 200 is simply biased towards a platform engagement surface by a biasing element 320. FIG. 8 shows an example of an arrangement in which the platform engagement surface 210 is provided by way of a notch (or open notch) 115, which may be referred to as a castellated or scalloped notch 115 by virtue of the ridges 112. Such a notch 115 may be formed in the radially inner surface 122 of the platform 120, as in the FIG. 8 example. Again, the biasing element 320 could take any suitable form, such as the spring 320 located and/or fixed in the platform 120 shown in the FIG. 8 example.

In general using a biasing element 310, 320 may allow the engagement load to be maintained at substantially the same level throughout the service life of the damper arrangement. For example, any wear/dimensional change over time (for example due to the friction at the interface of the engagement surfaces 110, 210) may be compensated for (for example passively) by the biasing element, such that the force provided by the biasing element, and thus the engagement load, remains substantially constant over time.

As explained elsewhere herein, the relative movement of the damper engagement surface 210 and the platform engagement surface 110 may result in energy dissipation, and thus vibration damping. This relative movement may be relative radial movement (or at least predominantly radial movement with, for example, some circumferential movement) and may rely on the damper engagement surface 210 being more radially fixed in position during operation (for example during diametral mode excitation of the rotor stage 100) than the platform engagement surface 110. In some arrangements, the damper engagement element 200 may be shaped (for example in cross section perpendicular to the circumferential direction) to be particularly stiff in the radial direction.

Purely by way of example, the damper element 200 may have a simple rectangular cross section perpendicular to the circumferential direction. Such a rectangular cross section may be longer in the radial direction than in the axial direction. The schematic damper elements of FIGS. 2 to 8 are examples of dampers 200 having such rectangular cross sections.

Purely by way of further example, the cross sectional shape may comprise one or more axial protrusions. For example, the damper element 200 shown by way of example in FIG. 9 has a cross section that comprises two axial protrusions 260 in cross section. The example shown in FIG. 9 may be said to have an I-shaped cross section. A damper element 200 having such a cross section may have increased stiffness compared with one of the same mass but having a rectangular cross section. However, it will be appreciated that a damper element 200 may have any suitable cross sectional shape, including but not limited to those described and/or illustrated herein by way of example.

Other than in the cross sectional shape of the damper element 200, the rotor stage 100 shown in FIG. 9 may be the same as that shown in FIG. 8. The FIG. 9 example is shown with a spring 320 biasing the damper element 200 towards the platform engagement surface 110, which is again formed by at least two ridges 112. However, it will be appreciated that the rotor stage 100 of FIG. 9 may have any one of the other features described and/or claimed herein, such as a clip 310 and/or a groove 180.

The resistance of the damper engagement surface 210 to radial movement may optionally be increased by radially fixing the damper element 200 to a part of the gas turbine engine 10 that is dimensionally (or at least radially and optionally also circumferentially) very stable in operation. Such a part of the gas turbine engine may rotate with the rotor stage 100 and/or be a part of the rotor stage 100. A drive assembly, for example including a drive arm and/or a spacer 190 and/or a disc 140, may be used as such a dimensionally stable part of the engine that rotates with the rotor stage. Such a drive assembly may be arranged to transfer torque within the engine 10. Also purely by way of example, an inner radial portion of the damper element 200 may be radially fixed to the dimensionally stable part.

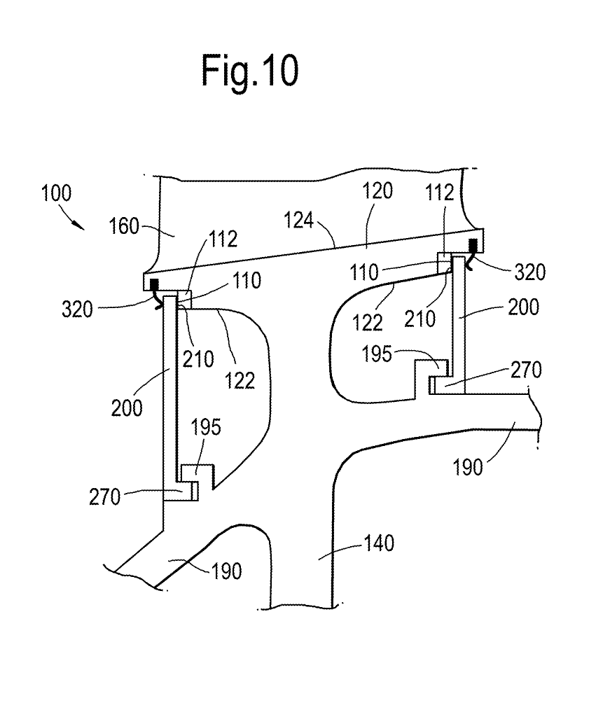

The exemplary rotor stage shown in FIG. 10 comprises a damper element 200 with a damper fixing hook 270 that radially fixes the damper element 200 to a dimensionally stable part, in this case a drive arm 190. The damper fixing hook 270 may be described as having an axially protruding portion and/or a circumferentially extending hook locating surface. The damper fixing hook 270 is connected to a corresponding drive arm fixing hook 195. The two fixing hooks 270, 195 cooperate to radially fix the damper element 200 to the drive arm 190.

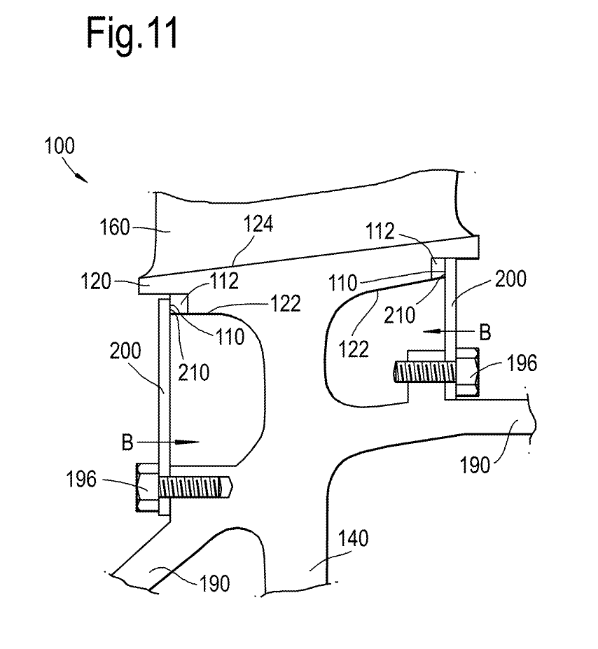

FIG. 11 shows, by way of further example, an alternative arrangement for radially fixing the damper element 200 to a drive assembly 190, in this case using a treaded fastener in the form of a bolt 196. The bolt 196 is tightenable in an axial direction indicated by the arrow B in FIG. 11. In addition to fixing the damper element 200 relative to the drive assembly 190, using a threaded fastener 196 may allow the engagement load of the damper engagement surface 210 against the platform engagement surface 110 to be adjusted and/or set as desired. For example, the engagement load may be adjusted by tightening (for example to increase the engagement load) or loosening (for example to decrease the engagement load) the threaded fastener 196. This may be useful, for example, either to set the engagement load to the desired in-service level and/or to adjust the engagement load during development/design of the damper assembly in order to determine the optimal engagement load. Thus, of course, the bolt (or other fastening element) 196 is an example of a biasing element.

The examples shown in FIGS. 10 and 11 comprise two damper elements 200, which are axially separated from each other. However, other arrangements may be as described in relation to FIG. 10 or FIG. 11, but instead comprise just one (or indeed more than two) damper elements 200. Similarly, other features such as the cross sectional shape of the damper elements 200 and the presence/form of the biasing elements 196, 320 are, of course, only exemplary in the arrangements of FIGS. 10 and 11 and may take different forms, such as (for example) those described and/or claimed elsewhere herein.

It will be understood that the invention is not limited to the arrangements and/or examples above-described and various modifications and improvements can be made without departing from the concepts described and/or claimed herein. Except where mutually exclusive, any of the features may be employed separately or in combination with any other features and the disclosure extends to and includes all combinations and sub-combinations of one or more features described and/or claimed herein.

1. A rotor stage for a gas turbine engine comprising:
a plurality of blades extending from a platform, the platform extending circumferentially about an axial direction; and
a circumferentially extending damper element, wherein:
the platform comprises a platform engagement surface;
the damper element comprises a damper engagement surface; and
the platform engagement surface engages the damper engagement surface over at least two separate engagement portions, the engagement portions being separated by a gap over which the platform engagement surface does not engage the damper engagement surface.

2. A rotor stage according to claim 1, wherein the engagement portions are circumferentially extending segments.

3. A rotor stage according to claim 2, wherein the engagement portions are annular segments.

4. A rotor stage according to claim 1, wherein the platform is ridged, thereby forming the at least two engagement portions separated by a gap.

5. A rotor stage according to claim 4, wherein the ridges protrude in a substantially axial direction.

6. A rotor stage according to claim 4, wherein the ridges protrude in a substantially radial direction.

7. A rotor stage according to claim 1, wherein the damper engagement surface is axisymmetric.

8. A rotor stage according to claim 1, wherein:
the damper engagement surface is an annular surface; and/or
the damper element is an annular disc.

9. A rotor stage according to claim 1, wherein:
the damper engagement surface and the platform engagement surface are moveable relative to each other in a radial direction, the platform being more radially deformable than the damper element.

10. A rotor stage according to claim 1, comprising more than two engagement portions.

11. A rotor stage according to claim 1, further comprising a contact layer on one or both of the platform engagement surface and the damper engagement surface, wherein the contact layer is:
a low-friction layer that has lower friction than the underlying surface to which it is applied; and/or
a hard layer that has increased hardness compared with the underlying surface to which it is applied.

12. A rotor stage according to claim 1, wherein the damper element and the platform are axially biased together, thereby providing an engagement load between the damper engagement surface and the platform engagement surface; and, optionally the rotor stage further comprising a biasing element that provides the axial bias by applying a force in the axial direction to the damper element to push the damper engagement surface onto the platform engagement surface.

13. A rotor stage according to claim 1, wherein the plurality of blades are formed integrally with the platform.

14. A gas turbine engine comprising a rotor stage according to claim 1.

15. A method of damping vibrations in a rotor stage of a gas turbine engine, wherein:
the rotor stage is a rotor stage according to claim 1;
the vibration comprises a travelling wave passing circumferentially around the circumferentially extending platform; and
the damping is frictional damping generated through radial and/or circumferential slip between the platform engagement surface and the damper engagement surface.
